(19) United States
(12) Patent Application Publication
(10) Pub. No.: US 2023/0337232 A1
(43) Pub. Date: Oct. 19, 2023

(54) SYSTEMS AND STRUCTURES OF UNMANNED AERIAL VEHICLES

(71) Applicant: SZ DJI TECHNOLOGY CO., LTD., Shenzhen (CN)

(72) Inventors: Jie QIAN, Shenzhen (CN); Shaojun YAN, Shenzhen (CN); Lei ZHU, Shenzhen (CN)

(73) Assignee: SZ DJI TECHNOLOGY CO., LTD., Shenzhen (CN)

(21) Appl. No.: 18/211,207

(22) Filed: Jun. 16, 2023

Related U.S. Application Data
(63) Continuation of application No. PCT/CN2020/137610, filed on Dec. 18, 2020.

(51) Int. Cl. H04W 72/1273; H04W 72/231; H04W 16/28

(52) U.S. Cl. CPC H04W 72/1273; H04W 72/231; H04W 16/28

(57) ABSTRACT

A system of an unmanned aerial vehicle (UAV) includes a first body of the UAV capable of flying, a second body detachably attached to the first body and capable of being a stabilizer, and a power supply system capable of powering the first body and the second body. The system further includes one or more sensors, at least one processor, and at least one storage medium storing instructions. When executed, the instructions in the at least one storage medium instruct the processor to receive sensor data from the one or more sensors.

### RELATED APPLICATIONS

This application is a continuation application of PCT application No. PCT/CN2020/137610, filed on Dec. 18, 2020, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to systems and structures of an unmanned aerial vehicle (UAV) that can quickly start and is easily portable.

### BACKGROUND

Nowadays, the technical aspects such as flying speed and obstacle avoidance capability alone are not the only factors to be considered by consumers and professionals when purchasing UAVs. UAVs find uses in different situations including, for example, travelling, capturing unexpected events, sports, entertainment, etc. In addition to the technical aspects, features like quick starting, easy portability and operation flexibility have become more and more crucial for UAVs to better meet challenges in these situations.

Conventionally, a user is required to use a secondary device, such as a remote controller or a mobile phone, to start and operate a UAV. To start a UAV, a user needs to take out and turn on the controller before using the controller to start the UAV. It may be necessary for the user to mount a cell phone on the remote controller, which may take additional time and effort. When an unexpected event happens and the user needs to record a video using the UAV, every second that can be saved for starting the UAV counts.

In some circumstances, such as travelling and hiking, users may have limited space for storing devices such as UAVs and their corresponding controllers, cameras, stabilizers, etc. Conventionally these devices are individual devices each requiring an individual storage space or container to secure for best use.

Conventionally, in cases requiring a user to use a secondary device such as a controller or a mobile phone to operate a UAV and devices on-board the UAV, it may take the user extra effort and time to learn, practice, and master the controlling process. In addition, the user may get distracted from an ongoing activity (e.g., a hike, a conference, a work-out, a festivity, etc.) as the user needs to divert the attention to operation of the controller or the mobile phone to communicate with the UAV. As such, while UAVs are becoming more intelligent and powerful for performing various autonomous functions, users may be frustrated by a cumbersome experience, or even discouraged from using UAVs as much as they would like to. As a result, users are not effectively taking full advantage of the UAV's intelligent and powerful functions, and are missing opportunities to timely record subject matter of interest with a camera on-board the UAV.

### SUMMARY

Consistent with some exemplary embodiments of the present disclosure, a system is provided for an unmanned aerial vehicle (UAV). The system includes a first body of a UAV capable of flying, a second body detachably attached to the first body and capable of being a stabilizer, and a power supply system capable of powering the first body and the second body. The system further includes one or more sensors, at least one processor, and at least one storage medium storing instructions. When executed, the instructions in the at least one storage medium instruct the processor to receive sensor data from the one or more sensors.

It is to be understood that both the foregoing general description and the following detailed description are exemplary and explanatory only, and are not restrictive of the disclosure, as claimed.

### BRIEF DESCRIPTION OF THE DRAWINGS

FIG. 1 shows an exemplary system of a UAV and a corresponding operating environment according to some exemplary embodiments of the present disclosure.

FIGS. 2A and 2B show an exemplary UAV including a first body and a second body according to some exemplary embodiments of the present disclosure.

FIG. 3 shows a second body of an exemplary UAV detached from a first body according to some exemplary embodiments of the present disclosure.

FIGS. 4A-4D show a first body of an exemplary UAV including a structure of one or more arms coupled to the first body according to some exemplary embodiments of the present disclosure.

FIG. 5 shows an exemplary UAV in a folded configuration including a first body and a second body according to some exemplary embodiments of the present disclosure.

FIG. 6A shows an exemplary obstacle avoidance mechanism and a corresponding sensor arrangement according to some exemplary embodiments of the present disclosure.

FIG. 6B shows an exemplary obstacle avoidance mechanism and a corresponding sensor arrangement according to some exemplary embodiments of the present disclosure.

FIGS. 6C and 6D show an exemplary obstacle avoidance mechanism and a corresponding sensor arrangement according to some exemplary embodiments of the present disclosure.

FIGS. 7A and 7B show an exemplary power supply system arrangement according to some exemplary embodiments of the present disclosure.

FIG. 8 shows another exemplary power supply system arrangement according to some exemplary embodiments of the present disclosure.

FIG. 9 illustrates several exemplary processor configurations according to some exemplary embodiments of the present disclosure.

FIGS. 10A-10C show an exemplary storage container configuration for a UAV according to some exemplary embodiments of the present disclosure.

### DETAILED DESCRIPTION

The following detailed description refers to the accompanying drawings. Wherever possible, the same reference numbers refer to the same or similar parts. While several illustrative embodiments are described herein, modifications, adaptations and other implementations are possible. For example, substitutions, additions or modifications may be made to the components illustrated in the drawings. Accordingly, the following detailed description is not limited to the disclosed exemplary embodiments and examples. Instead, the proper scope is defined by the appended claims.

Consistent with some exemplary embodiments of the present disclosure, there are provided systems and structures for a UAV that can quickly start and is easily portable.

According to some exemplary embodiments of the present disclosure, a system includes a first body of a UAV capable of flying and a second body detachably attached to the first body and capable of being a stabilizer. The first body includes one or more arms coupled to the first body and one or more propulsion devices mounted on the one or more arms. The system further includes one or more sensors configured to obtain data regarding conditions which affect movement of at least the first body. The second body includes a power supply system capable of powering the first body and the second body. The system further includes at least one processor and at least one storage medium storing instructions. When executed, the instructions in the storage medium instruct the processor to: receive data from the one or more sensors or a camera; process the data based on predetermined preprocessing settings; communicate with a server or a user device with the data or the preprocessed data; and transmit the data or preprocessed data to the server or the user device.

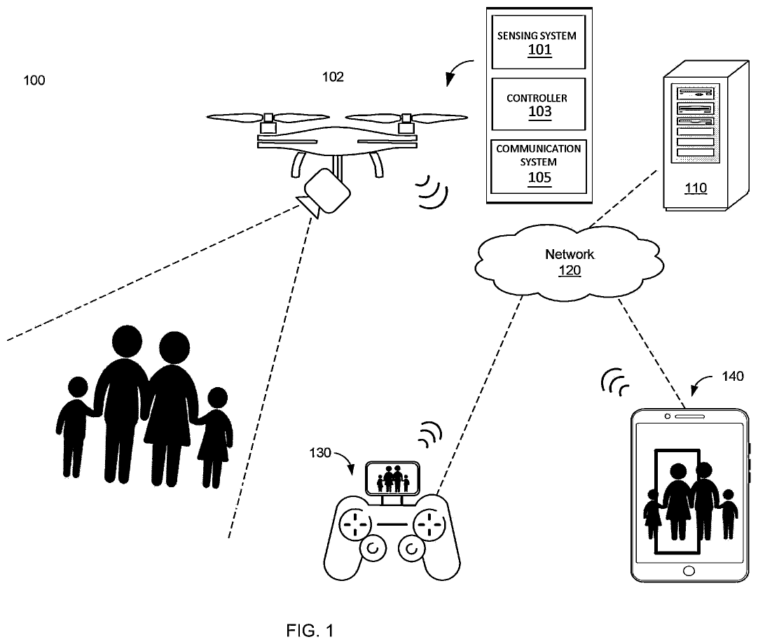

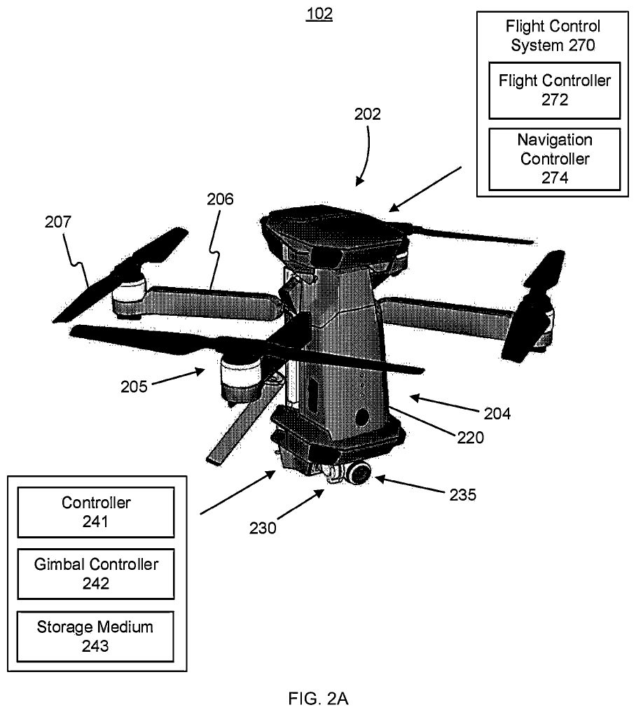

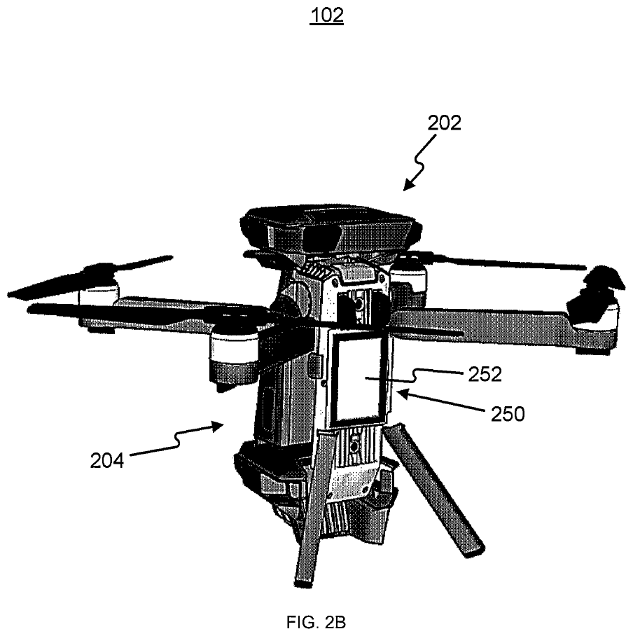

FIG. 1 shows an exemplary system 100 of a UAV 102 and a corresponding operating environment, according to some exemplary embodiments of the present disclosure. In FIG. 1, the representative UAV 102 is only diagrammatical with respect to its relationship with the corresponding operating environment in system 100. The structure of UAV 102 and details of subsystems of system 100 are described in detail with reference to FIGS. 2A-10C. UAV 102 includes a first body capable of flying and a second body detachably attached to the first body and capable of being a stabilizer, as described in detail with reference to FIGS. 2A-9. System 100 includes subsystems on-board UAV 102 (such as a sensing system 101, a controller 103, a communication system 105, etc.) and other system components such as a network 120, a server 110, and a mobile device 140.

In some exemplary embodiments, UAV 102 is capable of communicatively connecting with one or more electronic devices including a mobile device 140 and server 110 (e.g., a cloud-based server) via network 120 in order to exchange information with one another and/or other additional devices and systems. In some exemplary embodiments, system 100 includes a remote control 130 (also referred to herein as a terminal 130) and UAV 102 is also capable of communicatively connecting to terminal 130. In some exemplary embodiments, system 100 does not include a remote control when the second body is detachably attachable to the first body. The second body may act as a remote control when it is detached from the first body, as described in detail with reference to FIGS. 2A-4.

In some exemplary embodiments, network 120 may be any combination of wired and wireless local area network (LAN) and/or wide area network (WAN), such as an intranet, an extranet, and the Internet. In some exemplary embodiments, network 120 is capable of providing communications between one or more electronic devices, as discussed in the present disclosure. For example, UAV 102 is capable of transmitting data (e.g., image data and/or motion data) detected by one or more sensors on-board in real-time during movement of UAV 102 to other system components (such as remote control 130, mobile device 140, and/or server 110) that are configured to process the data via network 120. In addition, the processed data and/or operation instructions can be communicated in real-time among remote control 130, mobile device 140, and/or cloud-based server 110 via network 120. Further, operation instructions can be transmitted from remote control 130, mobile device 140, and/or cloud-based server 110 to UAV 102 in real-time to control the flight of UAV 102 and components thereof via any suitable communication technologies, such as local area network (LAN), wide area network (WAN) (e.g., the Internet), cloud environment, telecommunications network (e.g., 3G, 4G), Wi-Fi, ZigBee technology, Bluetooth, radiofrequency (RF), point to point communication such as Ocusync and Lightbridge, infrared (IR), or any other communications technology.

In some exemplary embodiments, network 120 includes at least one communication link that connects components and devices of UAV 102 with devices and components of system 100 for purpose of data transmission. The at least one communication link may include one or more connection ports of first body 202 or second body 204, or a wireless communication link, or a combination thereof. The at least one communication link may apply any suitable technology, such as ZigBee technology, Wi-Fi, etc. For example, communication system 105 includes a first communication link and a second communication link. The first communication link and the second communication link are independent of each other so that particular type of data can be communicated within system 100 more efficiently. Components of UAV 102 may be configured to be connected and exchange data with each other via the first communication link and the second communication link respectively. For example, the first communication link is configured to transmit sensor data for flight control such that system 100 may achieve intelligent flight control of UAV 102 by analyzing sensor data communicated via the first communication link. As another example, the second communication link is configured to transmit the sensor data to a user of UAV 102 or a ground unit of system 100. As yet another example, the first communication link is configured to exchange control signals and the second communication link is configured to exchange image data.

System 100 includes an on-board sensing system 101. Sensing system 101 may include one or more sensors associated with one or more components or other subsystems of UAV 102. For instance, sensing system 101 may include sensors for determining positional information, velocity information, and acceleration information relating to UAV 102 and/or its observing targets. In some exemplary embodiments, sensing system 101 may also include carrier sensors. Components of sensing system 101 may be configured to generate data and information that may be used (e.g., processed by controller 103 or another device) to determine additional information about UAV 102, its components, and/or its targets. Sensing system 101 may include one or more sensors for sensing one or more aspects of the movement of UAV 102. For example, sensing system 101 may include sensing devices associated with a load 235, as described below in detail with reference to FIG. 2A, and/or additional sensing devices, such as a positioning sensor for a positioning system (e.g., GPS, GLONASS, Galileo, Beidou, GAGAN, RTK, etc.), motion sensors, inertial sensors (e.g., IMU sensors, MIMU sensors, etc.), proximity sensors, imaging sensors, etc. Sensing system 101 may also include sensors configured to provide data or information relating to the surrounding environment, such as weather information (e.g., temperature, pressure, humidity, etc.), lighting conditions (e.g., light-source frequencies), air composition, or nearby obstacles (e.g., objects, structures, people, other vehicles, etc.).

Communication system 105 of UAV 102 may be configured to enable communication of data, information, commands, and/or other types of signals between on-board controller 103 and off-board entities, such as remote control 130, mobile device 140 (e.g., a mobile phone), server 110 (e.g., a cloud-based server), or another suitable entity. Communication system 105 may include one or more on-board components configured to send and/or receive signals, such as receivers, transmitters, or transceivers, which are configured for one-way or two-way communication. The on-board components of communication system 105 may be configured to communicate with off-board entities via one or more communication networks, such as radio, cellular, Bluetooth, Wi-Fi, RFID, and/or other types of communication networks usable to transmit signals indicative of data, information, commands, and/or other signals, including network 120. For example, communication system 105 may be configured to enable communication with off-board devices for providing input for controlling UAV 102 during flight, such as remote control 130 and/or mobile device 140.

On-board controller 103 of UAV 102 may be configured to communicate with various devices on-board UAV 102, such as communication system 105 and sensing system 101. Controller 103 may also communicate with a positioning system (e.g., a global navigation satellite system, or GNSS) to receive data indicating the location of UAV 102. On-board controller 103 may communicate with various other types of devices which may be on-board UAV 102 or off-board, including a barometer, an inertial measurement unit (IMU), a transponder, or the like, to obtain positioning information and velocity information of UAV 102. Controller 103 may also provide control signals (e.g., in the form of pulsing or pulse width modulation signals) to one or more electronic speed controllers (ESCs) of UAV 102, which may be configured to control one or more propulsion devices of UAV 102. On-board controller 103 may thus control the movement of UAV 102 by controlling one or more electronic speed controllers.

Off-board devices, such as remote control 130 and/or mobile device 140, may be configured to receive inputs, such as inputs from a user (e.g., user manual inputs, user speech inputs, user gestures captured by sensing system 101 of UAV 102), and communicate signals indicative of the inputs to controller 103. Based on the inputs from the user, the off-board device may be configured to generate corresponding signals indicative of one or more types of information, such as control data (e.g., signals) for moving or manipulating UAV 102 (e.g., via propulsion devices), a load 235, and/or a carrier. The off-board device may also be configured to receive data and information from UAV 102, such as data collected by or associated with load 235 and operational data relating to, for example, positional data, velocity data, acceleration data, sensing data, and other data and information relating to UAV 102, its components, and/or its surrounding environment. As discussed in the present disclosure, the off-board device may be remote control 130 with physical sticks, levers, switches, wearable apparatus, touchable display, and/or buttons configured to control flight parameters, and a display device configured to display image information captured by sensing system 101. Remote control 130 may be specifically designed for single-hand operation, thereby making UAV 102 and the devices and components corresponding to system 100 more portable. For example, the display screen may be smaller, the physical sticks, levers, switches, wearable apparatus, touchable display, and/or buttons may be more compact to make it easier for single-hand operation. The off-board device may also include mobile device 140 including a display screen or a touch screen, such as a smartphone or a tablet, with virtual controls for the same purposes, and may employ an application on a smartphone or a tablet, or a combination thereof. Further, the off-board device may include server system 110 communicatively coupled to network 120 for communicating information with remote control 130, mobile device 140, and/or UAV 102. Server system 110 may be configured to perform, in addition to or in combination with remote control 130 and/or mobile device 140, one or more functionalities or sub-functionalities. The off-board device may include one or more communication devices, such as antennas or other devices configured to send and/or receive signals. The off-board device may also include one or more input devices configured to receive input from a user, generate an input signal communicable to on-board controller 103 of UAV 102 for processing by controller 103 to operate UAV 102. In addition to flight control inputs, the off-board device may be used to receive user inputs of other information, such as manual control settings, automated control settings, control assistance settings, and/or aerial photography settings. It is understood that different combinations or layouts of input devices for an off-board device are possible and within the scope of this disclosure.

The off-board device may also include a display device 131 configured to display information, such as signals indicative of information or data relating to movements of UAV 102 and/or data (e.g., imaging data such as image data and video data) captured by UAV 102 (e.g., in conjunction with sensing system 101). In some exemplary embodiments, display device 131 may be a multifunctional display device configured to display information as well as receive user input. In some exemplary embodiments, the off-board device may include an interactive graphical interface (GUI) for receiving one or more user inputs. In some exemplary embodiments, the off-board device, e.g., mobile device 140, may be configured to work in conjunction with a computer application (e.g., an “app”) to provide an interactive interface on display device 131 or a multifunctional screen of any suitable electronic device (e.g., a mobile phone, a tablet, etc.) for displaying information received from UAV 102 and for receiving user inputs.

In some exemplary embodiments, display device 131 of remote control 130 or mobile device 140 may display one or more images received from UAV 102. In some exemplary embodiments, UAV 102 may also include a display device configured to display images captured by the sensing system 101. Display device 131 on remote control 130, mobile device 140, and/or on-board UAV 102, may also include interactive means, e.g., a touchscreen, for the user to identify or select a portion of an image of interest to the user. In some exemplary embodiments, display device 131 may be an integral component, e.g., attached or fixed, to the corresponding device. In some exemplary embodiments, display device 131 may be electronically connectable to (and dis-connectable from) a corresponding device (e.g., via a connection port or a wireless communication link) and/or otherwise connectable to the corresponding device via a mounting device, such as by clamping, clipping, clasping, hooking, adhering, or another type of mounting device. In some exemplary embodiments, display device 131 may be a display component of an electronic device, such as remote control 130, mobile device 140 (e.g., a mobile phone, a tablet, or a personal digital assistant), server system 110, a laptop computer, or other device.

In some exemplary embodiments, one or more electronic devices (e.g., UAV 102, server 110, remote control 130, or mobile device 140) as discussed with reference to FIG. 1 may have at least one processor and at least one storage medium storing instructions. When executed, the instructions may instruct the at least one processor to process data obtained from sensing system 101 of system 100 and UAV 102. The instructions may also instruct the at least one processor to identify a body posture of an operator, including one or more stationary bodily postures, attitudes, or positions identified in an image or images, or body movements determined based on a plurality of images. In some exemplary embodiments, the instructions may also instruct the at least one processor to determine user commands corresponding to the identified body gestures of the operator to control UAV 102. The electronic device(s) are further configured to transmit (e.g., substantially in real time with the flight of UAV 102) the determined user commands to related controlling and propelling components of system 100 and UAV 102 for corresponding control and operations. In some exemplary embodiments, on-board controller 103 may include at least one processor.

In some exemplary embodiments, the at least one storage medium of UAV 102 may store instructions that instruct the at least one processor of UAV 102 to process data obtained from sensing system 101. In some exemplary embodiments, the instructions may configure the communication system 105 to transfer data and data processing instructions and/or commands to one or more other suitable entities (e.g., server 110) through network 120 to process the data by the suitable entity. In some exemplary embodiments, the instructions to process the data may be based on user commands received from remote controller 130, mobile device 140, and/or other devices or components in system 100. For example, the instructions may cause the at least one processor to automatically transmit image data to server 110 and apply one or more predetermined image filters based on predetermined rules to edit the image data. This enables the user to quickly post the image on social media once received, thereby saving the user time on editing the image data. In some exemplary embodiments, the at least one processor may be placed in either or both of the first body and the second body. In some exemplary embodiments, there may be a first processor in the first body and a second processor in the second body. Each processor may include various types of processing devices. For example, each processor may include a microprocessor, a preprocessor (such as an image preprocessor), a graphics processing unit (GPU), a central processing unit (CPU), a support circuit, a digital signal processor, an integrated circuit, a memory, or any other type of device suitable for performing operation based on the instructions (e.g., flight control, processing data, computation, etc.), or a combination thereof. As another example, each processor may include any type of single or multi-core processor, mobile device microcontroller, etc.

In some exemplary embodiments, each processor may be categorized into either of two tiers (tier-one or tier-two) based on performance, capability, and specificity.

In some exemplary embodiments, a tier-one processor may have more processing power and include a large variety of functionalities. The tier-one processor may include a combination of one or more relatively more generalized processors and one or more relatively more specialized processing units designed for high-performance digital and vision signal processing. For example, the one or more relatively more generalized processors may include one or more digital signal processors (DSP), advanced RISC machine (ARM) processors, graphical processing units (GPU), or the like, or a combination thereof. For another example, the one or more relatively more specialized processing units may include one or more convolutional neural network (CNN) based adaptive cruise controls (ACC), vision-based ACCs, image signal processors (ISP), or the like, or a combination thereof. In some exemplary embodiments, a tier-two processor may include one or more processors having more limited functionality than the tier-one processor and may have a lower performance in certain areas such as image signal processing. For example, the tier-two processor may be an ARM M7 processor.

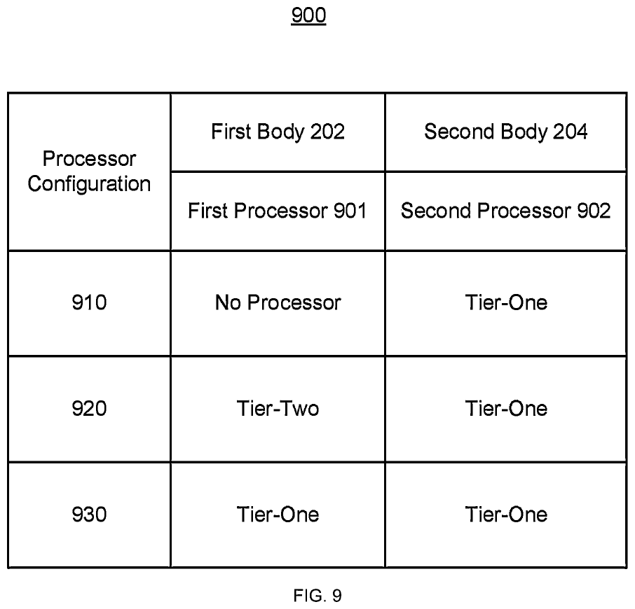

The two-tier categorization is on a relative scale related to processor selection and arrangement with respect to UAV 102. Categorizing processors as tier-one, tier-two, or removed from the tiers may change with the development of technology, upgrades of products, and may vary depending on the desired capabilities of UAV 102 and purposes of the related components of UAV 102. The arrangement of the processors in the first body and the second body of UAV 102 with respect to the two tiers is described in detail below with reference to FIG. 9.

In some exemplary embodiments, the application or software on mobile device 140 may receive the data and/or processed data. In some exemplary embodiments, the application or software may enable the user to edit the data or further edit the processed data. In some exemplary embodiments, the user may post the processed data directly or through the application to social media without transferring the processed data to another device such as a desktop computer. The application or the software on mobile device 140 may also enable the user to process the data by using the computing power of server 110 via network 120.

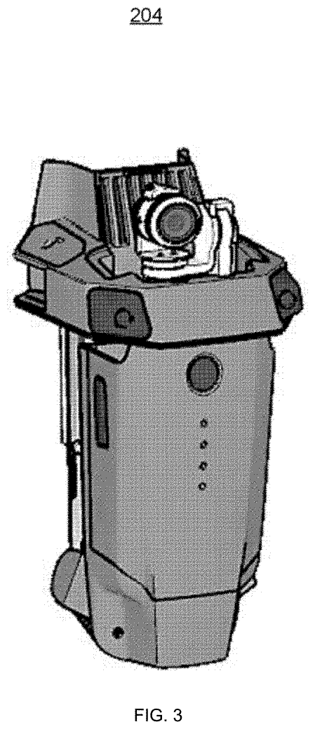

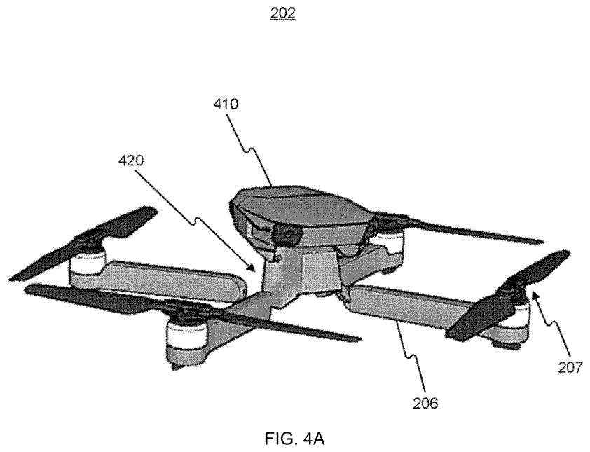

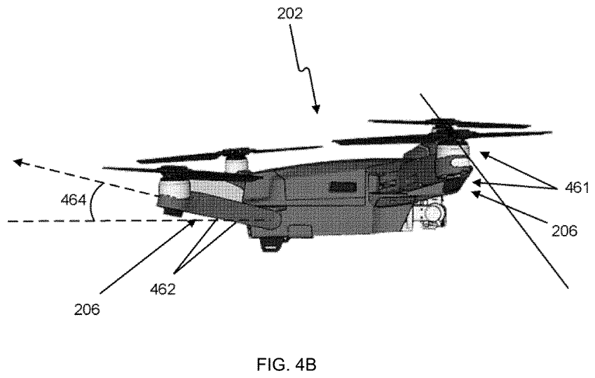

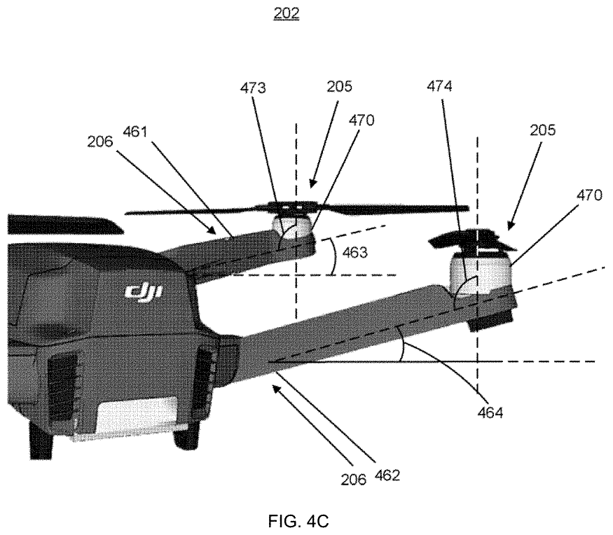

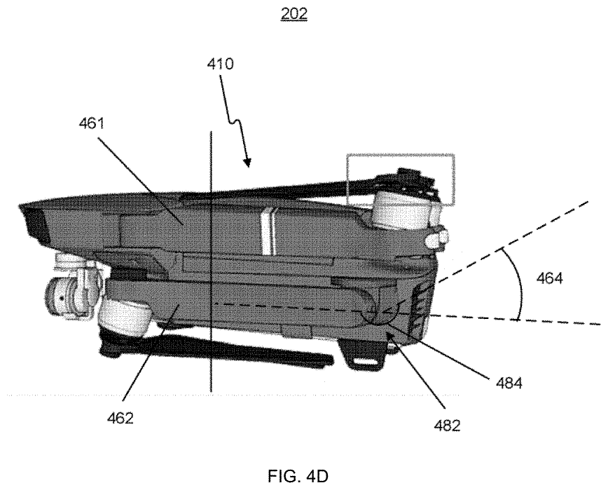

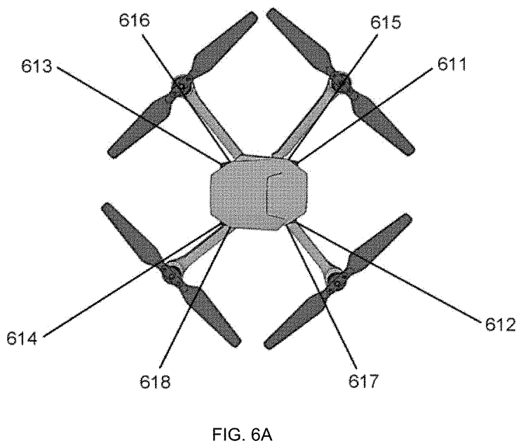

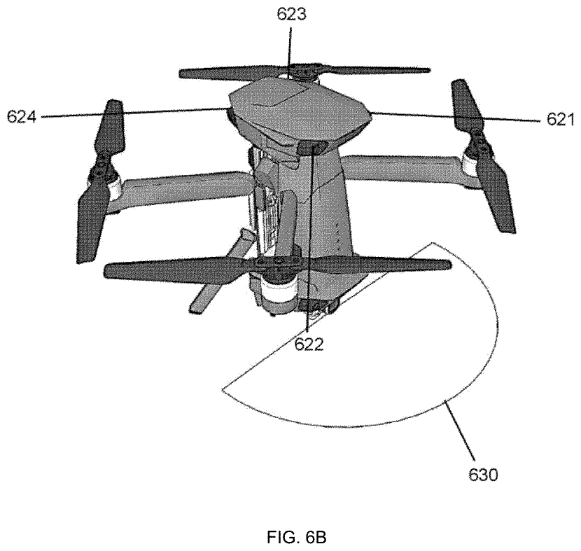

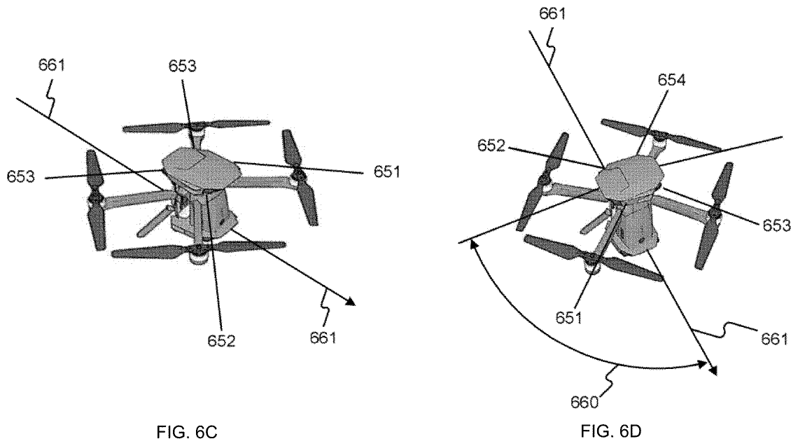

FIGS. 2A and 2B show exemplary UAV 102 including a first body 202 and a second body 204 according to some exemplary embodiments of the present disclosure. FIGS. 2A and 2B each shows UAV 102 from different observation angles. FIG. 3 shows second body 204 and FIGS. 4A-4D show first body 202. First body 202 and second body 204 may conduct some operations individually and collectively. First body 202 may fly individually without second body 204, as described in detail with reference to FIGS. 4A-4D. First body 202 may also fly with second body 204. First body 202 and second body 204 may also conduct some other operations collectively that they may not conduct individually. For example, first body 202 and second body 204 may act collectively to achieve omnidirectional obstacle avoidance, as described in detail with reference to FIGS. 6A-6D. When detached from first body 202, second body 204 may function individually as a ground unit (i.e., a device that a user may operate on the ground) such as a handheld stabilizer, as described in detail with reference to FIG. 3.

First body 202 and second body 204 may be detachably attached to each other by magnetic attraction, at least one structural attaching mechanism such as clamping or buckling, or the like, or a combination thereof. The physical interface between first body 202 and second body 204 includes a first physical interface of first body 202 and a second physical interface of second body 204. The physical interface between first body 202 and second body 204 may include a physical data interface for data exchange between first body 202 and second body 204. The physical interface and the data interface between first body 202 and second body 204 may be of a “uniform” type, such that upgrades and changes to either or both of first body 202 and second body 204 do not affect the physical interface and the data interface. For example, users can install software upgrades to enhance the flight control capability of first body 202 without affecting the compatibility between first body 202 and second body 204. As another example, users can purchase a new version of second body 204 or replace the image sensor associated with load 235 with a new one, and these replacements do not affect the compatibility between first body 202 and second body 204. This is economic and convenient for users because users may not need to upgrade or purchase both first body 202 and second body 204 at the same time, and may use different types of first body 202 and/or second body 204 and match them in different combinations to achieve certain operation purposes.

In some exemplary embodiments, first body 202 includes a magnetic attraction component and second body 204 includes a magnetic component such that first body 202 and second body 204 can be detachably attached to each other through magnetic attraction between the magnetic attraction component and the magnetic component. In some exemplary embodiments, second body 204 includes a magnetic attraction component and first body 202 includes a magnetic component. In some exemplary embodiments, the magnetic attraction component includes a magnetic shield component configured to prevent the magnetic attraction component from interfering with a magnetic sensor of UAV 102 (e.g., the compass). For example, the magnetic shield component is a metal piece. The metal piece is coupled to the magnetic attraction component to reduce magnetic circuit leakage, thereby reducing interference to a magnetic sensor, e.g., a compass of first body 202. In some exemplary embodiments, the metal piece may be a thin metal sheet.

In some exemplary embodiments, first body 202 includes a first buckling portion and second body 204 includes a second buckling portion such that first body 202 and second body can be detachably attached to each other through buckling of the first buckling portion and the second buckling portion. For example, the first buckling portion has a hook shape and the second buckling portion has a slot shape configured to buckle with the hook shape of the first buckling portion. As another example, the first buckling portion has a slot shape and the second buckling portion has a protrusion shape configured to buckle with the groove shape of the first buckling portion.

In some exemplary embodiments, first body 202 includes a damping device and second body 204 is detachably attached to the first body via the damping device. The damping device may include at least one of a vibration damping ball, a wire rope isolator, or a vibration isolation spring.

In some exemplary embodiments, first body 202 includes a first communication interface configured to exchange data for first body 202 and second body 204 includes a second communication interface configured to exchange data for second body 204. The first communication interface includes a first physical interface and the second communication interface includes a second physical interface.

As described above, the physical interface between first body 202 and second body 204 may include a physical data interface for data exchange between first body 202 and second body 204. Such physical data interface may be a connection between the first physical interface and the second physical interface. For example, when second body 204 is attached to first body 202, the first communication interface and the second communication interface are configured to exchange data through a connection between the first physical interface and the second physical interface.

In some exemplary embodiments, when second body 204 is detached from first body 202, first body 202 is capable of upgrading via the first communication interface, and second body 204 is capable of upgrading via the second communication interface. As described above, this capability of upgrading separately is economic and convenient for users because users may not need to upgrade both first body 202 and second body 204 at the same time, and may use different types of first body 202 and/or second body 204 and match them in different combinations to achieve certain operational purposes. In some exemplary embodiments, when second body 204 is detached from first body 202, first body 202 is configured to communicate externally via the first communication interface, and second body 204 is configured to communicate externally via the second communication interface.

In some exemplary embodiments, first body 202 may be disposed on top of second body 204, as shown in FIG. 2A. Second body 204 includes at least one range sensor configured to capture range data relating to surrounding environment. Second body 204 includes a load 235 configured to capture data and a controller 241 configured to process data captured by the load based on the range data captured by the at least one range sensor. The at least one processor may include the controller 241. The at least one range sensor is coupled to a flight controller of first body 202. The flight controller is configured to control the flight of first body 202 based on the range data captured by the at least one range sensor on second body 202.

In some exemplary embodiments, second body 204 may be disposed on top of first body 202. In cases where second body 204 is disposed on top of first body 202, certain components may need to be disposed differently to optimize the functionality of UAV 102. For example, an imaging sensor associated with load 235 may be omitted. Additional sensors may be disposed at the bottom of first body 202 to collect environmental data below UAV 102 during operation and there may be no sensors disposed at the top of first body 202. In some exemplary embodiments, first body 202 includes at least one range sensor configured to capture range data relating to surrounding environment. The at least one range sensor of first body 202 is coupled to a flight controller of first body 202. The flight controller is configured to control flight of first body 202 based on the range data captured by the at least one range sensor of first body 202.

Data from different input interfaces and sensors, data of different types, and data for different uses by UAV 102 may be exchanged between first body 202 and second body 204 together or separately, and may further be exchanged among devices and components of system 100, such as network 120, server 110, mobile device 140, etc. For example, data gathered from the imaging sensor(s) associated with load 235 of second body 204 for flight control may be exchanged via a separate communication link from data collected for image processing.

UAV 102 includes one or more (e.g., 1, 2, 3, 4, 5, 10, 15, 20, etc.) propulsion devices 205 positioned at one or more locations (for example, top, sides, front, rear, and/or bottom of UAV 102) for propelling and steering UAV 102. In some exemplary embodiments, UAV 102 may include one or more arms coupled to first body 202. The one or more propulsion devices 205 are positioned on the one or more arms 206 coupled to first body 202. Propulsion devices 205 are devices or systems operable to generate forces for sustaining controlled flight. Propulsion devices 205 may share or may each separately include or be operatively connected to a power source, such as a motor (e.g., an electric motor, a hydraulic motor, a pneumatic motor, etc.), an engine (e.g., an internal combustion engine, a turbine engine, etc.), a battery bank, etc., or a combination thereof. Each propulsion device 205 may also include one or more rotary components 207 drivably connected to a power source (not shown) and configured to participate in the generation of forces for sustaining controlled flight. For instance, rotary components 207 may include rotors, propellers, blades, nozzles, etc., which may be driven on or by a shaft, axle, wheel, hydraulic system, pneumatic system, or other component or system configured to transfer power from the power source. Propulsion devices 205 and/or rotary components 207 may be adjustable (e.g., tiltable) with respect to each other and/or with respect to UAV 102. Alternatively, propulsion devices 205 and rotary components 207 may have a fixed orientation with respect to each other and/or UAV 102. In some exemplary embodiments, each propulsion device 205 may be of the same type. In some exemplary embodiments, propulsion devices 205 may be of multiple different types. In some exemplary embodiments, all propulsion devices 205 may be controlled in concert (e.g., all at the same speed and/or angle). In some exemplary embodiments, one or more propulsion devices may be independently controlled with respect to, e.g., speed and/or angle.

Propulsion devices 205 may be configured to propel UAV 102 in one or more vertical and horizontal directions and to allow UAV 102 to rotate about one or more axes. That is, propulsion devices 205 may be configured to provide lift and/or thrust for creating and maintaining translational and rotational movements of UAV 102. For instance, propulsion devices 205 may be configured to enable UAV 102 to achieve and maintain desired altitudes, provide thrust for movement in all directions, and provide steering for UAV 102. In some exemplary embodiments, propulsion devices 205 may enable UAV 102 to perform vertical takeoffs and landings (i.e., takeoff and landing without horizontal thrust). Propulsion devices 205 may be configured to enable movement of UAV 102 along and/or about multiple axes.

In some exemplary embodiments, load 235 includes a sensing device that is part of sensing system 101. The sensing device associated with load 235 may include devices for collecting or generating data or information, such as surveying, tracking, and capturing images or video of targets (e.g., objects, landscapes, subjects of photo or video shoots, etc.). The sensing device may include an imaging sensor configured to collect data that may be used to generate images. In some exemplary embodiments, image data obtained from the imaging sensor may be processed and analyzed to obtain commands and instructions from one or more users to operate UAV 102 and/or the imaging sensor. In some exemplary embodiments, the imaging sensor may include photographic cameras, video cameras, infrared imaging devices, ultraviolet imaging devices, x-ray devices, ultrasonic imaging devices, radar devices, etc. The sensing device may also or alternatively include devices for capturing audio data, such as microphones or ultrasound detectors. The sensing device may also or alternatively include other suitable sensors for capturing visual, audio, and/or electromagnetic signals.

A carrier 230 may include one or more devices configured to hold load 235 and/or allow load 235 to be adjusted (e.g., rotated) with respect to UAV 102. For example, carrier 230 may be a gimbal. Carrier 230 may be configured to allow load 235 to be rotated about one or more axes, as described below. In some exemplary embodiments, carrier 230 may be configured to allow load 235 to rotate about an axis of each degree of freedom by 360° to allow for better control of the perspective of load 235. In some exemplary embodiments, carrier 230 may limit the range of rotation of load 235 to less than 360° (e.g., 270°, 210°, 180, 120°, 90°, 45°, 30°, 15°, etc.) about one or more of its axes.

Carrier 230 may include a frame assembly, one or more actuator members, and one or more carrier sensors. The frame assembly may be configured to couple load 235 to UAV 102 and, in some exemplary embodiments, to allow load 235 to move with respect to UAV 102. In some exemplary embodiments, the frame assembly may include one or more sub-frames or components movable with respect to each other. The actuator members are configured to drive components of the frame assembly relative to each other to provide translational and/or rotational motion of load 235 with respect to UAV 102. In some exemplary embodiments, the actuator members may be configured to directly act on load 235 to cause motion of load 235 with respect to the frame assembly and UAV 102. The actuator members may be or may include suitable actuators and/or force transmission components. For example, the actuator members may include electric motors configured to provide linear and/or rotational motion to components of the frame assembly and/or load 235 in conjunction with axles, shafts, rails, belts, chains, gears, and/or other components.

The carrier sensors may include devices configured to measure, sense, detect, or determine state information of carrier 230 and/or load 235. State information may include positional information (e.g., relative location, orientation, attitude, linear displacement, angular displacement, etc.), velocity information (e.g., linear velocity, angular velocity, etc.), acceleration information (e.g., linear acceleration, angular acceleration, etc.), and or other information relating to movement control of carrier 230 or load 235, either independently or with respect to UAV 102. The carrier sensors may include one or more types of suitable sensors, such as potentiometers, optical sensors, vision sensors, magnetic sensors, motion or rotation sensors (e.g., gyroscopes, accelerometers, inertial sensors, etc.). The carrier sensors may be associated with or attached to various components of carrier 230, such as components of the frame assembly or the actuator members, or to UAV 102. The carrier sensors may be configured to communicate data and information with on-board controller 103 of UAV 102 via a wired or wireless connection (e.g., RFID, Bluetooth, Wi-Fi, radio, cellular, etc.). Data and information generated by carrier sensors and communicated to controller 103 may be used by controller 103 for further processing, such as for determining state information of UAV 102 and/or targets.

Carrier 230 may be coupled to UAV 102 via one or more damping elements configured to reduce or eliminate undesired shock or other force transmissions to load 235 from UAV 102. Damping elements may be active, passive, or hybrid (i.e., having active and passive characteristics). Damping elements may be formed of any suitable material or combinations of materials, including solids, liquids, and gases. Compressible or deformable materials, such as rubber, springs, gels, foams, and/or other materials may be used as damping elements. The damping elements may function to isolate load 235 from UAV 102 and/or dissipate force propagations from UAV 102 to load 235. Damping elements may also include mechanisms or devices configured to provide damping effects, such as pistons, springs, hydraulics, pneumatics, dashpots, shock absorbers, and/or other devices or combinations thereof.

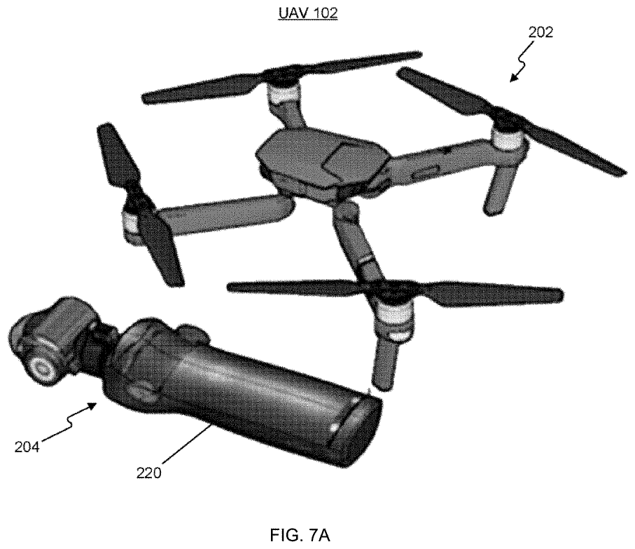

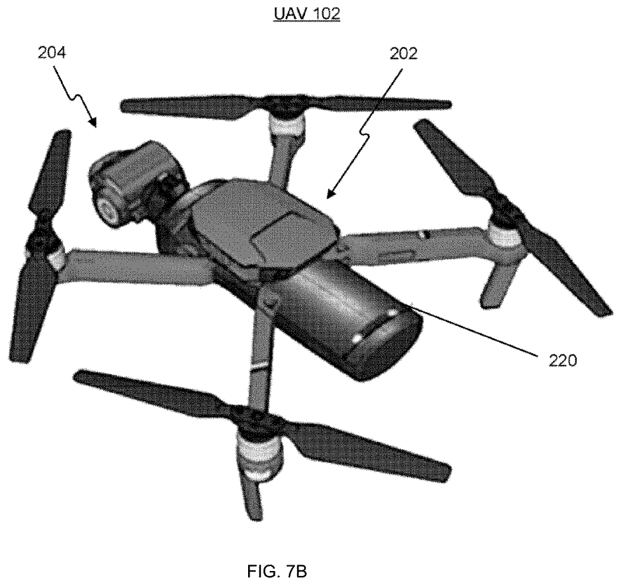

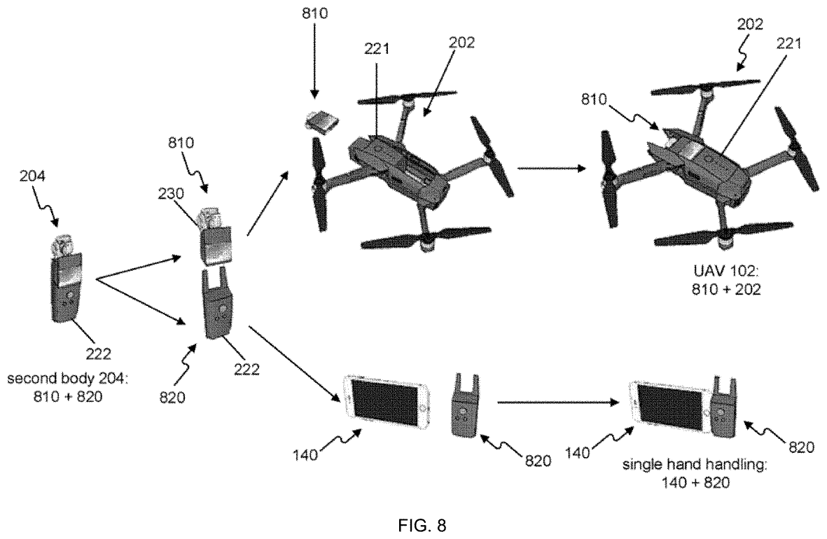

A power supply system 220 may be a device configured to power or otherwise supply power to electronic components, mechanical components, or combinations thereof in UAV 102. Power supply system 220 may be a battery, a battery bank, or other device. In some exemplary embodiments, power supply system 220 may be or include one or more of a combustible fuel, a fuel cell, or another type of power supply system. Power supply system 220 may power the one or more sensors on UAV 102. Power supply system 220 may power first body 202 and components of first body 202 for conducting operations. For example, power supply system 220 may power first body 202 to fly by powering the propulsion devices 205 on the one or more arms 206 to actuate the one or more rotary components 207, e.g., propellers, to rotate. Power supply system 220 may power second body 204 and components of second body 204 for conducting operations. For example, power supply system 220 may power a user interface 250 and load 235 on second body 204. Power supply system 220 is described in more detail with reference to FIGS. 7A, 7B, and 8.

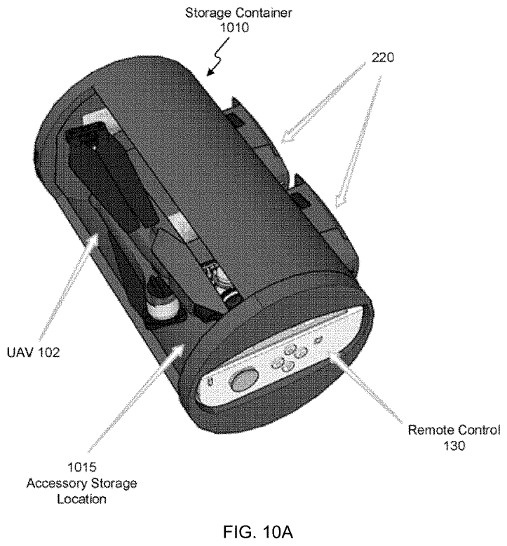

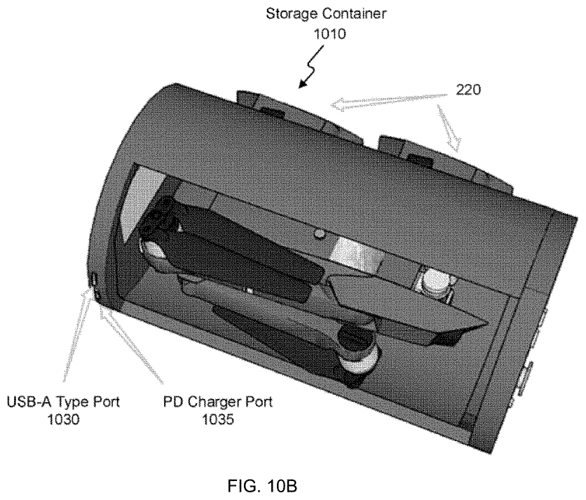

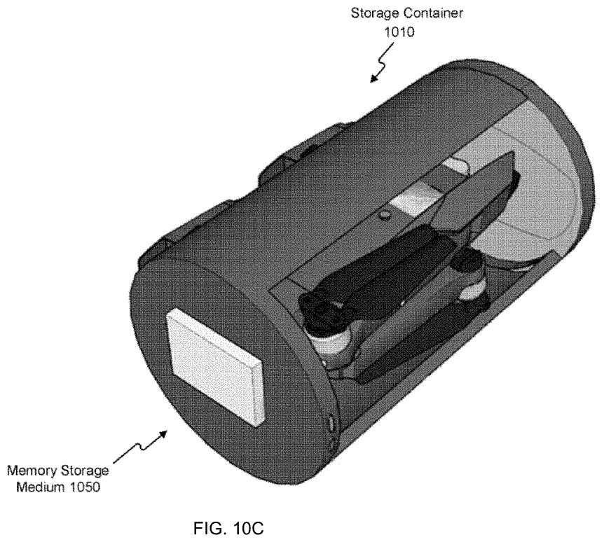

In some exemplary embodiments, power supply system 220 may act as a power source for devices or components other than the electronic components, mechanical components, or combinations thereof in UAV 102. This is particularly useful and economic in the sense of maximizing the use of energy stored in power supply system 220 because when the remaining power is below a certain level, power supply system 220 may not be suitable to power UAV 102 for another safe flight until it is recharged. The remaining power may still relieve users of the burden to bring other power source(s) to charge other devices such as mobile phones and cameras. In some exemplary embodiments, there may be at least one additional power supply system 220 as a backup power source. In some exemplary embodiments, other devices and components may be charged by power supply system 220 as a power source by directly connecting to power supply system 220. In some exemplary embodiments, other devices and components may charge from power supply system 220 by connecting to UAV 102 or via other charging devices or mechanisms. For example, a storage container for UAV 102 or power supply system 220 may include such charging function. Users can connect both power supply system 220 and a device to be charged on the storage container to charge the device using the power stored in power supply system 220. Users can use power supply system 220 to charge the storage container for UAV 102, and may also use the storage container to charge power supply system 220. The storage container is described in detail with reference to FIGS. 10A-10C.

In some exemplary embodiments, the at least one processor of UAV 102 may be in either first body 202 or second body 204. In some exemplary embodiments, first body 202 and second body 204 may each include at least one processor according to some exemplary embodiments of the present disclosure. In some exemplary embodiments, the at least one storage medium of UAV 102 may be in either first body 202 or second body 204. In some exemplary embodiments, first body 202 and second body 204 may each include at least one storage medium according to some exemplary embodiments of the present disclosure.

In some exemplary embodiments, first body 202 includes a flight control system 270 configured for flight control of first body 202. Flight control system 270 may include a flight controller 272 generating flight control commands to control the flight of first body 202. Flight control system 270 of first body 202 may include a flight sensing system. The flight sensing system includes at least one range sensor configured to capture data relating to the surrounding environment. For example, the at least one range sensor may include at least one of a ToF (time of flight) sensor, a monocular sensor, a binocular sensor, an infrared sensor, an ultrasonic sensor, and a LIDAR sensor. The flight sensing system may also include a sensing processor configured to process data captured by the at least one range sensor. In some exemplary embodiments, flight control system 270 includes a navigation controller 274 configured to navigate first body 202. Navigation controller 274 is in communication with flight controller 272.

In some exemplary embodiments, carrier 230 is a gimbal and second body 204 includes a gimbal controller 242 configured to control the attitude of carrier 230. In some exemplary embodiments, gimbal controller 242 is in communication with the flight controller of first body 202. Gimbal controller 242 is configured to receive status information of load 235, such as attitude of load 235 and operation status of load 235. Flight control system 270 of first body 202 is configured to receive the status information of load 235 from gimbal controller 242 and adjust status (such as attitude, operation mode, operation parameters, etc.) of first body 202 based on the status information of load 235. Gimbal controller 242 may also be configured to receive status information of first body 202 from flight control system 270. The status information of first body 202 includes attitude, operation mode, operation parameters, and other status information of first body 202. Gimbal controller 242 may be further configured to adjust status of load 235 (such as attitude and operation status of load 235) based on the status information of first body 202. In some exemplary embodiments, controller 241 and gimbal controller 242 are the same controller. In some exemplary embodiments, controller 241 and gimbal controller 242 are different controllers. In some exemplary embodiments, second body 204 includes a storage medium 243, in second body 204, configured to store image data.

In the exemplary embodiment of FIG. 2B, second body 204 includes user interface 250. User interface 250 may include one or more buttons, one or more physical sticks, at least one screen, other user interfaces, or a combination thereof. In some exemplary embodiments, user interface 250 may include a screen providing information related to UAV 102. The information may be related to at least one of first body 202 and second body 204. In some exemplary embodiments, user interface 250 may be configured to display information, such as signals indicative of information or data relating to movements of UAV 102 and/or data (e.g., imaging data) captured by UAV 102 (e.g., in conjunction with sensing system 101). In some exemplary embodiments, user interface 250 may display a signal in a specific way to indicate information of UAV 102 to users at a distance. For example, user interface 250 may display simple and bright colors to indicate different movement status of UAV 102.

In some exemplary embodiments, user interface 250 may include a touch screen 252 capable of receiving user commands. The user commands may be commands that affect first body 202, second body 204, other components or devices in system 100, or a combination thereof. In some exemplary embodiments, via user interface 250, a user may give user command(s) that cause UAV 102 to conduct one or more automated missions. In some exemplary embodiments, after giving user command(s) the user may leave UAV 102 at a location, and UAV 102 may start the one or more automated missions based on the user command(s) received via user interface 250. In some exemplary embodiments, after giving user command(s) the user may throw UAV 102, and UAV 102 may start the one or more automated missions based on the user command(s) received through user interface 250. In some exemplary embodiments, system 100 may also receive user commands by identifying an input from a user (e.g., user manual input, user speech input, user gestures captured by sensing system of UAV 102), as descried above.

In some exemplary embodiments, a user command may cause UAV 102 to (1) take off; (2) fly in a predetermined trajectory with respect to a predetermined target based on one or more predetermined parameters; (3) determine that at least one ending condition is met; and (4) land at the take-off location.

In some exemplary embodiments, a user command may cause UAV 102 to (1) take off; (2) fly in a predetermined trajectory based on one or more predetermined parameters; (3) determine that at least one ending condition is met; and (4) land at the take-off location.

In some exemplary embodiments, a user command may cause UAV 102 to (1) take off; (2) follow a predetermined target based on one or more predetermined parameters; (3) determine that at least one ending condition is met; and (4) land at a location with respect to the target based on one or more predetermined parameters.

In some exemplary embodiments, the at least one ending condition may be predetermined based on a user command. In some exemplary embodiments, the at least one ending condition may be a loss of target, a predetermined flying time, a predetermined flight length, a distance from the predetermined target, a completion of predetermined flight trajectory, an identification of a specific input from the user, etc.

In some exemplary embodiments, the trajectory may be a circle hovering around a target or a point with respect to a target, a spiral curve with increasing or decreasing distance from an axis, a line along which UAV 102 may move and pause, etc.

In some exemplary embodiments, the one or more predetermined parameters on which the predetermined trajectory is based may be a distance from the axis or the target, flight speed related parameters (such as speed limit, average speed, acceleration, etc.), height related parameters, the timing of pause and hovering during the flight, etc.

In some exemplary embodiments, UAV 102 may conduct at least one of a plurality of missions during flight based on a user command. The plurality of missions includes taking image(s) or video(s) of at least one predetermined target, taking image(s) or video(s) of an environment, taking image(s) or video(s) with one or more effects (such as zooming in, zooming out, slow motion, etc.), collecting data with sensing system 101, or other missions, or a combination thereof.

In some exemplary embodiments, before taking off for a flight based on a user command, UAV 102 may first conduct an automated self-inspection and environmental inspection. The automated self-inspection may include checking a plurality of conditions of UAV 102 that may affect the flight. The plurality of conditions in self-inspection may include remaining battery level, conditions of subsystems and components of system 100, data about UAV 102 from sensing system 101, connection to network 120, etc. The environmental inspection may include checking a plurality of conditions of the surrounding environment that may affect the flight. The plurality of conditions in environmental inspection may include weather information (e.g., temperature, pressure, humidity, etc.), lighting conditions (e.g., light-source frequencies), air constituents, or nearby obstacles (e.g., objects, structures, people, other vehicles, etc.). In some exemplary embodiments, environmental inspection may further include determining whether the environment is suitable for taking off based on conditions that may affect taking off. For example, system 100 may determine whether the environment is suitable for taking off based on conditions such as stability and levelness of the platform that UAV 102 is placed on, and the height and density of nearby obstacles, etc. In some exemplary embodiments, putting UAV 102 on the ground is a suitable condition for taking off. In some exemplary embodiments, UAV 102 may wait for a predetermined period of time after getting ready to take off. This may give the user some time to walk away or conduct some preparations.

In some exemplary embodiments, a user command may specify that UAV 102 will take off in a “paper plane” mode. In the paper plane mode, UAV 102 may start conducting one or more missions after the user launches UAV 102 by throwing it. After selecting a user command of paper plane mode, the user may further select one or more predetermined parameters and/or give other user command(s) related to one or more missions. Then the user may launch UAV 102 by throwing to enable UAV 102 to start. After receiving the user command of paper plane mode, system 100 may detect an event that UAV 102 is being thrown or has been thrown based on data received from one or more components of sensing system 101 (such as inertial sensors, motion sensors, proximity sensors, positioning sensor, etc.), and calculate based on the data.

In some exemplary embodiments, after detecting an event that UAV 102 is being thrown or has been thrown, system 100 may calculate an initial direction and an initial speed resulting from the throw based on data received from sensing system 101. For example, the initial direction resulting from the throw may be determined by finding the data from an inertial sensor at a time point when UAV 102 is being thrown or has been thrown. System 100 may determine the time point for determining the initial direction based on predetermined rules. In some exemplary embodiments, the predetermined rules may include identifying a change in the acceleration as an indication that UAV 102 is no longer in contact with a force provider, in the case of the throwing user. As another example, the initial speed resulting from the throw may be determined by finding an average speed, based on data from motion sensors and inertial sensors, during UAV 102 being thrown or has been thrown.

In some exemplary embodiments, in the paper plane mode, UAV 102 may conduct a self-adjustment after detecting an event that UAV 102 is being thrown or has been thrown. In some exemplary embodiments, the self-adjustment may be based on data received from sensing system 101. In some exemplary embodiments, the self-adjustment may be based on the determined initial direction, the determined initial speed, data received from sensing system 101, other factors, or a combination thereof. For example, system 100 may determine that the initial direction resulting from the throw is toward the ground and may adjust the direction of UAV 102 upward. In some exemplary embodiments, the self-adjustment may be based on a location of a predetermined target, the determined initial direction, other factors, or a combination thereof. For example, system 100 may conduct self-adjustment by correcting the direction towards the target from the initial direction resulting from the throw. In some exemplary embodiments, UAV 102 may conduct a self-adjustment any time during a flight based on one or more predetermined parameters or missions. In some exemplary embodiments, the self-adjustment may be based on a comparative location of UAV 102 from the user. For example, system 100 may determine a new direction based on a direction away from the location of the user.

FIG. 3 shows second body 204 detached from first body 202 of exemplary UAV 102 according to some exemplary embodiments of the present disclosure. Second body 204 of UAV 102 may individually function as a device for a user to operate on the ground. In some exemplary embodiments, second body 204 may function as a handheld stabilizer. In some exemplary embodiments, second body 204 may include a stabilizer portion and a handheld handle portion, as described in more detail with reference to FIG. 8.

In some exemplary embodiments, second body 204 may also function as a remote control of first body 202 of UAV 102. In accordance with some disclosed embodiments, a user may send user commands to first body 202 via user interface 250 of second body 204.

FIGS. 4A-4D show first body 202 of exemplary UAV 102 according to some exemplary embodiments of the present disclosure. With reference to FIG. 4A, first body 202 may fly individually without second body 204. In some exemplary embodiments, first body 202 may be specifically designed to emphasize on some characteristics to achieve desired purposes and/or to better conduct some missions. For example, first body 202 may be a racing vehicle when flying individually without second body 204. First body 202 may include a compartment to contain a power source.

In some exemplary embodiments, the power source of first body 202 may be an additional power supply system 220. In some exemplary embodiments, the power source of first body 202 may be different from power supply system 220. For example, the power source of first body 202 may be lighter and smaller, which may be more suitable for some designs for first body 202 that is focused on fast speed and light weight.

In some exemplary embodiments, first body 202 may include one or more components of sensing system 101. For example, in some exemplary embodiments, first body 202 may include one or more imaging sensors. The one or more imaging sensors may include photographic cameras, video cameras, infrared imaging devices, ultraviolet imaging devices, x-ray devices, ultrasonic imaging devices, radar devices, etc. In some exemplary embodiments, first body 202 may include sensors for determining positional information, velocity information, and acceleration information relating to UAV 102 and/or its observing targets. First body 202 may also include sensors configured to provide data or information relating to the surrounding environment, such as weather information (e.g., temperature, pressure, humidity, etc.), lighting conditions (e.g., light-source frequencies), air constituents, or nearby obstacles (e.g., objects, structures, people, other vehicles, etc.).

In some exemplary embodiments, first body 202 may include at least two layers. FIG. 4A shows an exemplary two-layer structure of first body 202. In FIG. 4A, first body 202 includes a first layer 410 and a second layer 420. One or more arms 206 are coupled to second layer 420 of first body 202. First layer 410 and second layer 420 are described in detail with reference to FIGS. 6C and 6D.

FIGS. 4B-4D show in further detail the structure of one or more arms 206 coupled to first body 202. In some exemplary embodiments, one or more arms 206, when unfolded, may extend from first body 202 of UAV 102 at an upward angle(s) with respect to first body 202. The features described with reference to FIGS. 4B-4D may be applicable to structures and systems according to some exemplary embodiments, such as UAV 102 having first body 202 and second body 204. In some exemplary embodiments, the features and benefits may be applicable to UAV structures and systems that are different from UAV 102, such as a UAV that has just one body. For example, the features and benefits may be applicable to first body 202 configured to fly individually without second body 204.

As shown in FIG. 4B, one or more arms 206 may include two front arms 461 and two rear arms 462. Each of the front arms 461 and rear arms 462 may extend from first body 202 at an upward angle with respect to first body 202. The upward angle may be an acute angle, such as an angle of 5 degrees, 10 degrees, 15 degrees, or 20 degrees. In some exemplary embodiments, the upward angle for front arms 461 and rear arms 462 may be the same. In some exemplary embodiments, the upward angles may be different for one or more of arms 206. For example, with reference to FIG. 4C, two front arms 461 may extend at an upward angle 463, while two rear arms 462 extend at a different upward angle 464,

FIG. 4C shows one front arm 461 and one rear arm 462 in a view from behind first body 202. Both front arm 461 and rear arm 462 are unfolded. In some exemplary embodiments, one propulsion device 205 is positioned on each front arm 461 and rear arm 462. Each propulsion device 205 may be different from or the same as another one of propulsion devices 205. In some exemplary embodiments, each propulsion device 205 includes a rotor 470. In FIG. 4C, each rotor 470 positioned on each front arm 461 and rear arm 462 may be level with respect to first body 202, such that each rotor 470 rotates about an axis parallel to a top-down direction of first body 202. For example, when first body 202 is placed on a horizontal plane, each rotor 470 of unfolded front arm 461 and rear arm 462 is also horizontal and rotates along a vertical axis.

As shown in FIG. 4C, front arm 461 may extend from first body 202 at an upward angle 463, and rear arm 462 may extend from first body 202 at an upward angle 464. Upward angle 463 is the angle between the direction along which front arm 461 extends from first body 202 and the horizontal body plane of first body 202. Upward angle 464 is the angle between the direction along which rear arm 462 extends from first body 202 and the horizontal body plane of first body 202. In some exemplary embodiments, upward angle 463 may be the same as upward angle 464 to maintain rotors 470 level with respect to first body 202. In some exemplary embodiments, upward angle 463 may be different from upward angle 464 to maintain rotors 470 level with respect to first body 202 to compensate for a difference in the structure of front arms 461 and rear arms 462. Such structural arrangement of arms having upward angle(s) with respect to first body 202 may provide benefits to structures, systems, and operation of first body 202 and UAV 102. For example, arms 461 and 462 may be extended at an upward angle or angles that lower(s) a center of mass of first body 202 relative to propulsion devices 205. This may be beneficial for flight control and dynamics of first body 202 and UAV 102. As another example, such structural arrangement of arms may reduce or remove obstruction to the side of first body 202 by rearranging one or more arms 206 and propulsion devices 205. Therefore, more devices and functionalities may be enabled, for example, sensors may be placed on the side of first body 202 without being obstructed.

In some exemplary embodiments, rotors 470 may not be parallel to the one or more arms 206 on which rotors 470 are positioned, such that the rotating axes of rotors 470 may remain vertical (i.e., rotating axes of rotors 470 remain perpendicular to horizontal body plane of first body 202 and rotors 470 remain level with respect to first body 202) while front arm 461 or rear arm 462 may have an upward angle(s) with respect to first body 202 (i.e., not parallel to horizontal body plane of first body 202).

In some exemplary embodiments, upward angles 463 and 464 may be no less than a certain number of degrees such that propulsion devices 205, e.g., propellers, are above first body 202. The upward angle(s) may be selected to ensure that propulsion devices 205 do not interfere with first body 202 when operating. This may also reduce constraints on the design of the propellers in terms of parameters such as the size, force generated by operation thereof, and the horizontal location of the propellers with respect to the horizontal body plane of first body 202, etc.

FIG. 4D shows first body 202 in an exemplary folded configuration with front arms 461 and rear arms 462 folded and closely placed relative to first body 202. In some exemplary embodiments, front arms 461 and rear arms 462 may each be coupled to first body 202 via one or more devices including a pivoting device with an angle stop mechanism that limits the pivoting angle of an arm up to a maximum rotating angle. In some exemplary embodiments, such maximum rotating angle may be optimized to allow one or more of front arms 461 and rear arms 462 to extend from first body 202 at an optimized upward angle or angles. For example, in FIG. 4D, rear arm 462 is coupled to first body 202 via one or more devices including a pivoting device 482. Pivoting device 482 has an angle stop mechanism that limits rotation of rear arm 462 around a horizontal axis and up to a maximum rotating angle 484. In some exemplary embodiments, maximum rotating angle 484 may be optimized to enable unfolded rear arm 462 to extend at upward angle 464 for arranging propulsion device 205 of rear arm 462 above first body 202.

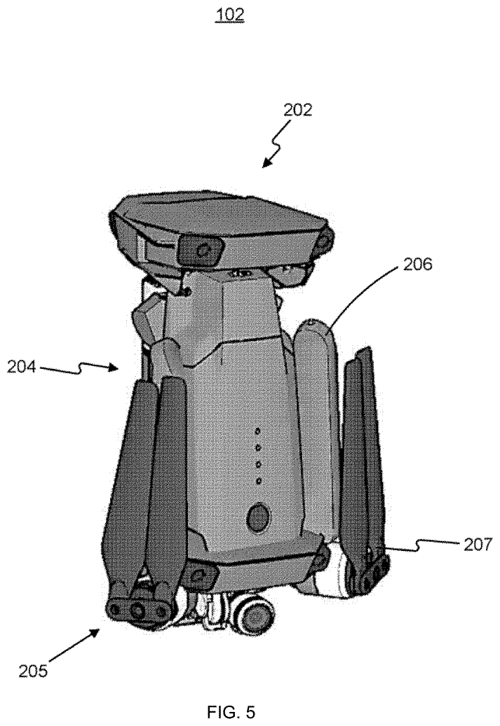

FIG. 5 shows exemplary UAV 102 in a folded configuration including first body 202 and second body 204 according to some exemplary embodiments of the present disclosure. FIG. 5 also shows another state of arms 206 in a folded configuration that is different from FIG. 4D. Conventionally, to achieve similar functionality as UAV 102, a user would need at least a conventional UAV, a remote control for the conventional UAV, and a device for users on the ground such as a handheld stabilizer, thus the user requires much more space to store all these separate devices rather than storing just the folded UAV 102. FIGS. 4D and 5 show exemplary folded configurations that may save space compared to storing these separate devices conventionally.

In some exemplary embodiments, arms 206 may be detachable from UAV 102. For example, arms 206 and first body 202 are connected with electromechanical connectors, and arms 206 can be detached at the electromechanical connectors and stored separately from UAV 102. In some exemplary embodiments, arms 206 and propulsion devices 205 may also be detachable.

In some exemplary embodiments, the sensors configured to provide range data (such as vision data, distance data, etc.) may have a limited field of view (FOV) (e.g., the horizontal angle of view of each sensor is no more than 64°). In some exemplary embodiments, some or all of the sensors may have wide-angle FOV (e.g., the horizontal angle of view is between 64° and 114°) or may be fisheye sensors (e.g., the horizontal angle of view is larger than 114°).

FIGS. 6A-6D show exemplary obstacle avoidance mechanisms and corresponding sensor arrangements according to some exemplary embodiments of the present disclosure. In FIGS. 6A-6D, UAV 102 is illustrated using sensors having limited FOV to obtain range data relating to the surrounding environment. Omnidirectional obstacle avoidance is achieved with sensors having limited FOV by applying exemplary obstacle avoidance mechanisms and corresponding sensor arrangements. In some exemplary embodiments other than those shown in FIGS. 6A-6D, UAV 102 may use sensors having limited FOV, wide-angle FOV, fisheye, or the like, or a combination thereof to obtain range data relating to the surrounding environment. The types of sensors used by UAV 102 to obtain range data includes time of flight (ToF) sensors, monocular sensors, binocular sensors, infrared sensors, ultrasonic sensors, LIDAR sensors, or the like, or a combination thereof.

FIG. 6A shows an exemplary obstacle avoidance mechanism and a corresponding sensor arrangement according to some exemplary embodiments of the present disclosure. The corresponding sensor arrangement includes arrangement of one or more range sensors including distance sensors (such as ultrasonic sensors), vision sensors, etc. Distance sensors are sensors configured to capture distance data of targets, objects, or environments, etc. Vision sensors are sensors configured to capture vision data, such as image data or video data. As shown in FIG. 6A, four pairs of range sensors (range sensors 611-618) are located respectively on the front (range sensors 611 and 612), the rear (range sensors 613 and 614), the left side (range sensors 615 and 616), and the right side (range sensors 617 and 618) of first body 202 of UAV 102. In some exemplary embodiments, each pair of range sensors are located and directed to cover a horizontal angle of view of at least 90° towards the pair's direction (e.g., front pair of range sensors 611 and 612 cover at least 90° towards the front direction), such that omnidirectional obstacle avoidance is achieved. In some exemplary embodiments, one or more pairs of range sensors may cover an angle of view that is less than 90° but the combination of the angles of view by all four pairs of range sensors cover all horizontal angles, such that omnidirectional obstacle avoidance is achieved. In some exemplary embodiments, more range sensors may be used in addition to the four pairs of range sensors and may be placed at other locations on UAV 102. For example, one pair of range sensors may be placed on the top of first body 202. As another example, one pair of range sensors may be placed on bottom edges of second body 204. In some exemplary embodiments, the range sensors may be placed individually rather than in pairs. For example, a range sensor may be placed at the center of the front of first body 202.

The disclosed exemplary embodiments related to obstacle avoidance mechanisms and sensor arrangements are not necessarily limited in their application to the details of construction and the arrangements set forth herein with respect to and/or illustrated in the drawings and/or the examples. The disclosed exemplary embodiments may have variations, or may be practiced or carried out in various ways. In some exemplary embodiments, the one or more range sensors include a number of range sensors different from the above four pairs in total, and are not limited to being arranged in pairs. For example, the one or more range sensors include a ToF sensor, a monocular sensor, a binocular sensor, an infrared sensor, an ultrasonic sensor, or a LIDAR sensor, or a combination thereof, on some or all of the rear, the front, the left side, the right side, and other locations of UAV 102, such as the top of first body 202 and bottom edges of second body 204.

FIG. 6B shows another exemplary obstacle avoidance mechanism and a corresponding sensor arrangement according to some exemplary embodiments of the present disclosure. In FIG. 6B, two pairs of range sensors (range sensors 621-624) are located respectively at the front (range sensors 621 and 622) and the rear (range sensors 623 and 624) of first body 202 of UAV 102. During a flight, carrier 230 may adjust load 235 to rotate with respect to UAV 102 to keep range sensors associated with load 235 facing towards a target. In some exemplary embodiments, load 235 may rotate to cover an angle 630 of 180°. In some exemplary embodiments, load 235 includes a range sensor associated with load 235. The range sensor associated with load 235 may cover an angle of view wider than angle 630. For example, a range sensor with limited FOV of 60° may be associated with load 235 and cover an angle of view of 240° with angle 630. The range sensor associated with load 235 may achieve omnidirectional (360°) obstacle avoidance or substantially 360° obstacle avoidance (e.g., 357°, 350°, 345°, etc.) with the two pairs of range sensors on front and rear sides of first body 202 of UAV 102. First body 202 may be face the flying direction of UAV 102. In some exemplary embodiments, second body 204 may face in the same direction as first body 202. In some exemplary embodiments, controller 103 may control second body 204 to adjust itself to face towards the same target as load 235. In some exemplary embodiments, more range sensors may be used in addition to the two pairs of range sensors on first body 202 and may be placed at other locations on first body 202. In some exemplary embodiments, the range sensors may be placed individually rather than in pairs. For example, a range sensor may be placed at the center of the front of first body 202.

FIGS. 6C and 6D show an exemplary obstacle avoidance mechanism and a corresponding sensor arrangement according to some exemplary embodiments of the present disclosure. In some exemplary embodiments, first body 202 may include at least two layers. In FIGS. 6C and 6D, two pairs of range sensors (range sensors 651-654) are located respectively at front (range sensors 651 and 652) and rear (range sensors 653 and 654) sides of first layer 410 of first body 202 of UAV 102. The one or more propulsion devices 205 are positioned on the one or more arms 206 coupled to second layer 420 of first body 202. In some exemplary embodiments, first layer 410 of first body 102 may be connected with second layer 420 of first body 202 via a steering mechanism that steers only first layer 410 of first body 202 relative to second layer 420, such that range sensors 651-654 located on first layer 410 of first body 202 may rotate with respect to the one or more arms 206 coupled to second layer 420 of first body 202. In some exemplary embodiments, first layer 410 may be at a position higher than that of second layer 420 of first body 202. The steering mechanism may rotate first layer 410 of first body 202 with respect to second layer 420 of first body 202 of UAV 102 so that the two pairs of range sensors may achieve omnidirectional obstacle avoidance. Flying direction 661 is the direction that UAV 102 flies towards during a flight. In some steering mechanism, the rotation by the steering mechanism may rotate first layer 410 to the left or the right side of flying direction 661 by angular range 660. In some exemplary embodiments, angle 660 may be 90°.

In some exemplary embodiments, more range sensors may be used in addition to the two pairs of range sensors and may be placed at other locations on first body 202. In some exemplary embodiments, the range sensors may be placed individually rather than in pairs. For example, a range sensor may be placed at the center of the front of first body 202.

FIGS. 7A and 7B show an exemplary power supply system arrangement according to some exemplary embodiments of the present disclosure. In some exemplary embodiments, power supply system 220 may only be placed on second body 204 of UAV 102, as shown in the exemplary power supply system arrangement in FIG. 7A. In FIG. 7B, power supply system 220 may power first body 202 and components of first body 202 when first body 202 is connected with second body 204. This power supply system arrangement has benefits for second body 204, such as a longer battery life and being ready for second body 204 to use without additional time to install a power supply system. However, this arrangement may lead to an increase in the size and the weight of power supply system 202 and second body 204.

In some exemplary embodiments, UAV 102 may include at least two power supply systems 220. FIG. 8 shows an exemplary power supply system arrangement including at least two power supply systems, according to some exemplary embodiments of the present disclosure. In FIG. 8, first body 202 includes a first power supply system 221, and second body 204 includes a second power supply system 222. First power supply system 221 may or may not be the same power supply system as second power supply system 222. In some exemplary embodiments, first power supply system 221 may be capable of independently powering first body 202, and second power supply system 222 may be capable of independently powering second body 204. First power supply system 221 and second power supply system 222 may each be smaller and lighter than power supply system 220 shown in FIGS. 7A and 7B because there is only one power supply system 220 to power both first body 202 and second body 204. Therefore, second body 204 in FIG. 8 may also be smaller and lighter compared to second body 204 in FIGS. 7A and 7B.

In some exemplary embodiments, second power supply system 222 is detachable from second body 204 based on different operating conditions. For example, as shown in FIG. 8, second power supply system 222 is coupled to second body 204 and powers second body 204 when second body 204 operates individually as a ground unit. In FIG. 8, second power supply system 222 is detachable from second body 204 when second body 204, without second power supply system 222, is connected with first body 202. In some exemplary embodiments, second body 204 without second power supply system 222 may be a stabilizer portion 810 of second body 204, as described more fully below. When second body 204, without second power supply system 222, is operating while connected with first body 202, first power supply system 221 powers second body 204. This may enhance the efficiency of using first power supply system 221 because UAV 102 is free from the weight of second power supply system 222 when operating with both first body 202 and second body 204.

In some exemplary embodiments, second power supply system 222 may not be detachable from second body 204 (except in special situations such as repair and maintenance). In some exemplary embodiments, power supply system 220 may be attached to second body 204 as an internal power supply system. For example, when second body 204 is connected with first body 202 and UAV 102 is operating, second power supply system 222 is also carried by UAV 102, even though second power supply system 222 may or may not power first body 202. Second power supply system 222 may be the only power source to power second body 204. This enables the quick use of UAV 102 and second body 204 without the need for additional time to mount power supply system 222. However, this may increase the carrying burden on first body 202 when it is connected with second body 204 because second power supply system 222 is also carried. In some exemplary embodiments, second power supply system 222 may not be detachable from second body 204 even when second power supply system 222 is being charged. However, in some exemplary embodiments, second power supply system 222 may be detachable from second body 204 when second power supply system 222 is being charged, but may still not be detachable from second body 204 when second body 204 is operating.

In some exemplary embodiments, power supply system 220 may include a combination of subsidiary power supply systems under a unified power management system. Each subsidiary power supply system under the unified power management system may independently power one or more components of UAV 102 (e.g., imaging sensor, first body 202, second body 204, etc.). In some exemplary embodiments, each subsidiary power supply system under the unified power management system may be capable of powering one or more of the same components as some other such subsidiary power supply system.

In some exemplary embodiments, power supply system 220 may include a combination of first power supply system 221 and second power supply system 222 under a unified power management system. First power supply system 221 may or may not be the same as second power supply system 222. For example, first power supply system 221 may be a two-cell (2S) battery and second power supply system 222 may be a one-cell (1S) battery. As another example, first power supply system 221 may be a LiPo three-cell (LiPo 3S) battery and second power supply system 222 may be a LiPo six-cell (LiPo 6S) battery. While the exemplary use of 1S, 2S, 3S, and 6S batteries has been described, the embodiments can also be practiced with other battery types. In some exemplary embodiments, the unified power management system manages a powering relationship between the power supply devices and power management data such as remaining battery life. For example, when first body 202 is connected with second body 204, first power supply system 221 may power UAV 102 together with second power supply system 222. In some exemplary embodiments, the unified power management system manages only the power management data related to power supply system 220. Alternatively, first power supply system 221 may only power first body 202, and second power supply system 222 may only power second body 204. For example, when first body 202 is connected with second body 204, first power supply system 221 powers only first body 202, and second power supply system 222 powers only second body 204. The power management data of first power supply system 221 and second power supply system 222, such as their remaining battery life and whether there is a signal of abnormal condition, are communicated with the unified power management system.

As shown in FIG. 8, in some exemplary embodiments, second body 204 may include a stabilizer portion 810 and a handheld portion 820. Stabilizer portion 810 and handheld portion 820 may detach from each other. In some exemplary embodiments, at least one of stabilizer portion 810 and handheld portion 820 may be capable of operating without the other. For example, stabilizer portion 810 may operate as a stabilizer for first body 202 or a device other than UAV 102. As another example, handheld portion 820 may function as a handheld handle for another device, such as mobile device 140.

In some exemplary embodiments, stabilizer portion 810 may be connected with first body 202. Stabilizer portion 810 may be configured to carry load 235 associated with one or more vision sensors, such that first body 202 may operate as a UAV with the one or more vision sensors to conduct a video shooting mission. Stabilizer portion 810 may include carrier sensors that provide state information with respect to first body 202. In some exemplary embodiments, handheld portion 820 includes second power supply system 222, such that stabilizer portion 810 and its components may rely on first power supply system 221 when being connected with first body 202 without handheld portion 820. In some exemplary embodiments, stabilizer portion 810 and handheld portion 820 may each include a portion of power supply system 222, such that the portion may power stabilizer portion 810 or its components when stabilizer portion 810 is detached from handheld portion 820.

In some exemplary embodiments, handheld portion 820 includes second power supply system 222 and an image transmission system. Handheld portion 820 may power other portions or components of second body 204, such as when handheld portion 820 is not detached from stabilizer portion 810. The image transmission system may process and transmit signals from one or more vision sensors associated with load 235 of stabilizer portion 810. The transmission of signals may be on a real-time basis when handheld portion 820 is connected with stabilizer portion 810.

In some exemplary embodiments, handheld portion 820 may include components and systems of second body 204 such that handheld portion 820 is capable of performing functionalities of or as second body 204 when detached from stabilizer portion 810. For example, handheld portion 820 may still be capable of conducting a remote control function for second body 204 when detached from stabilizer portion 810.

In some exemplary embodiments, handheld portion 820 may independently perform functionalities that second body 204 may or may not be capable of when handheld portion 820 is connected with stabilizer portion 810. For example, handheld portion 820 may conduct a remote control function when detached from stabilizer portion 810. It may be easier for a user to hold handheld portion 820 with a single hand than to hold second body 204 including both handheld portion 820 and stabilizer portion 810. Therefore, in some exemplary embodiments, the handheld portion 820, rather than the whole second body 204, may be used as a remote controller for single hand handling. Furthermore, handheld portion 820 may be configured to make it convenient for single hand handling of a connected combination of handheld portion 820 and mobile device 140. Handheld portion 820 may perform transmission and receiving functions of signals with other components of system 100. For example, when a user is holding handheld portion 820, handheld portion 820 may assist subsystems and components of system 100 with identifying a user or input from the user.

In some exemplary embodiments, a user may connect handheld portion 820 with mobile device 140 to enable additional functionalities. For example, the user may connect handheld portion 820 with a mobile phone and use the mobile phone to perform remote control functions and process signals from UAV 102. The image transmission system and associated hardware components of handheld portion 820 may enable or enhance signal transmission, receiving, and processing by the user using mobile device 140 connected with handheld portion 820. Power supply system 222 on handheld portion 820 may provide additional power to mobile device 140 when connected. In some exemplary embodiments, mobile device 140 may in turn power handheld portion 820 when connected.

FIG. 9 illustrates several exemplary processor configurations 900 according to some exemplary embodiments of the present disclosure. In some exemplary embodiments, the at least one processor of UAV 102 may only be disposed in second body 204, as illustrated in processor configuration 910. All data collected by first body 202 may be processed by the at least one processor in second body 204. In some exemplary embodiments, data exchange between first body 202 and second body 204 may be separately via a data interface that is a physical interface. This may save the cost of placing a processor and related hardware such as memory in first body 202. However, this may lead to additional complexity of the physical interface between first body 202 and second body 204, thereby increasing a burden of design and potentially undermining stability of the physical interface. In some exemplary embodiments, data exchange between first body 202 and second body 204 may be via both wireless link(s) and physical interface.

In some exemplary embodiments, the at least one processor in second body 204 may be a tier-one processor (processor configuration 910). This may be necessary for UAV 102 to achieve tasks that require high processing and computational power, such as complex real-time vision processing tasks.

In some exemplary embodiments, first body 202 and second body 204 may each have at least one processor. For example, the at least one processor in first body 202 may be a first processor 901 and the at least one processor in second body 204 may be a second processor 902, as illustrated in each of processor configurations 920 and 930.

In some exemplary embodiments, processor 901 may be a tier-two processor and processor 902 may be a tier-one processor (processor configuration 920). For example, tier-two processor 901 may be an ARM M7 processor that can handle certain flight control function for first body 102. However, processor 901 may not handle certain complex tasks such as real-time vision processing and may not be capable of large volume data storage. Tier-one processor 902 may handle the more complex vision processing tasks based on range data transmitted from first body 202. Instead of having a tier-one processor in first body 202, a tier-two processor such as an ARM M7 processor may save cost for constructing UAV 102, and may also benefit design and operation from energy efficiency perspective.

In some exemplary embodiments, similar to processor configuration 910, in processor configuration 920 there may be certain complex tasks that need to be handled by tier-one processor 902 in second body 204, and data exchange between first body 202 and second body 204 may be conducted via a physical data interface. This processor configuration may lead to additional complexity of the physical interface between first body 202 and second body 204, thereby increasing a burden of design and potentially undermining stability of the physical interface. In some exemplary embodiments, data exchange between first body 202 and second body 204 may be conducted via both wireless link(s) and physical interface.

In some exemplary embodiments, processor 901 and processor 902 may each be a tier-one processor, as illustrated in processor configuration 930. For example, processor 901 and processor 902 may each include at least one of a DSP or a GPU, and at least one of CNN-based ACC, vision-based ACC, or ISP, or the like, or a combination thereof. Therefore, processor 901 and processor 902 may each conduct a full range of tasks as needed by first body 202 and second body 204. This processor configuration may reduce the burden of data exchange between processor 901 and processor 902, such that the data interface between processor 901 and processor 902 may be less complex and more stable.

In some exemplary embodiments, processor 901 is configured to process flight control data for flight control, and processor 902 is configured to process image data. Processor 901 may be further configured to process data of the surrounding environment. In some exemplary embodiments, load 235 of second body 204 is in communication with processor 902 through the first communication link and the second communication link. For example, load 235 may transmit data through the first communication link for flight control such that system 100 achieves intelligent flight control of UAV 102 by analyzing sensor data communicated through the first communication link. As another example, load 235 may transmit sensor data through the second communication link to a user of UAV 102 or a ground unit of system 100.

In some exemplary embodiments, processor 901 has a weaker data processing capability than processor 902. For example, processor 901 is a tier-two processor and processor 902 is a tier-one processor. As another example, processor 901 has a lower operating frequency than processor 902. Processor 901 is configured to process flight control data for flight control, and processor 902 is configured to process image data and data of the surrounding environment captured by sensing system 101. For example, first body 202 may include at least one range sensor configured to transmit its captured sensor data to processor 902 through the first communication link. Processor 902 is configured to process the sensor data received from the at least one range sensor to generate processed sensor data. Processor 902 is further configured to transmit the processed sensor data to processor 901 through the second communication link.

FIGS. 10A-10C show an exemplary storage container configuration for an UAV according to some exemplary embodiments of the present disclosure. In FIG. 10A, a storage container 1010 may provide space to store UAV 102. Storage container 1010 may also provide different location(s), such as one or more accessory storage locations 1015, to place certain components and devices of or associated with UAV 102. For example, storage container 1010 may contain one or more receiving portions to place power supply system 220. As another example, storage container 1010 may provide a specific accessory storage location 1015 for users to store ND lens filter(s) so that the ND lens filter(s) may be better protected and not easily lost. In some exemplary embodiments, UAV 102 may be stored with first body 202 and second body 204 separated.

In FIG. 10A, storage container 1010 may include one or more locations for storing off-board devices such as remote control 130 in accordance with some exemplary embodiments of the present disclosure. In some exemplary embodiments, storage container 1010 may contain one or more receiving portions to place devices or components of system 100 that may receive user inputs without a need to remove the devices or components from storage container 1010. For example, this may enable a user to directly use remote control 130 stored in a receiving portion of storage container 1010 to send user inputs to an operating UAV 102 out of storage container 1010. As another example, a user may store second body 204 in the receiving portion and use touch screen 252 of second body to send user commands to an operating first body 202 in the air.

In FIG. 10B, storage container 1010 contains two receiving portions to receive two power supply systems 220 simultaneously. In some exemplary embodiments, the number of receiving portions and the number of power supply systems 220 as backup for power supply system 220 of UAV 102 may be different depending on various factors considered in UAV 102 product design, such as portability, battery life requirement, and whether UAV 102 is designed for professional, prosumer, or consumer use. In some exemplary embodiments, the receiving portions may also be specific to different subsidiary power supply systems of power supply system 220.

In some exemplary embodiments, power supply system 220 may charge other devices via storage container 1010. For example, a user may use a USB-A type port 1030 on the side of storage container 1010, as shown in FIG. 10B. This may maximize the use of energy stored in power supply system 220 because when the remaining power is below a certain level, power supply system 220 may not be suitable to power UAV 102 for another safe flight until it is recharged. This is also consistent with the portability of UAV 102 to reduce the burden of bringing other power source(s) for other devices or for recharging.

In some exemplary embodiments, a user may charge power supply system 220 using storage container 1010. For example, the user may use each of the two receiving portions to place power supply system 220 in order to charge power supply system 220. In some exemplary embodiments, storage container 1010 includes one or more charging circuits for charging components including power supply system 220. The two receiving portions for the two power supply systems 220 include power connectors. When power supply systems 220 are stored in the two receiving portions, the power connectors and the one or more charging circuits connect power supply system 220 with a power source of storage container 1010 so that the power source can charge power supply system 220. In some exemplary embodiments, the user may charge storage container 1010 using power supply system 220.

As another example, a user may use one or more external power connectors, such as PD (power delivery) charger port 1035 on the side of storage container 1010, to charge power supply system(s) 220, as shown in FIG. 10B. PD charger port 1035 is connected with the one or more charging circuits for charging external devices or components including power supply system 220. The power provided by PD charger port 1035 may be directly used for charging power supply system 220 or may be collected and/or stored by an intermediate power supply system of storage container 1010. The PD charger port 1035 may further be managed by an intelligent power storage management system that monitors conditions of power supply system 220 and controls the charging of power supply system 220. In some exemplary embodiments, the intelligent power storage management system may be the same as, associated with, a sub part of, or a parent system of the unified power management system that manages the subsidiary power supply systems of power supply system 220, as described above with reference to FIG. 8.

In FIG. 10C, when UAV 102 is stored in storage container 1010, UAV 102 may exchange data with storage container 1010. The data exchange between UAV 102 and storage container 1010 may be automatic once UAV 102 and storage container 1010 are connected by a data interface. In some exemplary embodiments, storage container 1010 includes a memory storage medium 1050 to receive and store data received from UAV 102, such as range data. Memory storage medium 1050 may be a solid state drive (SSD), a secure digital card (SD card), a T-Flash card (TF card), an internal memory storage medium such as a hard disk drive, or other suitable memory storage medium. In some exemplary embodiments, the at least one processor of UAV 102 automatically uploads the data captured by the one or more sensors of UAV 102 to memory storage medium 1050 when first body 202 or second body 204, with which the at least one processor is associated, is stored in storage container 1010.

In some exemplary embodiments, storage container 1010 includes a wireless communication device capable of communicating with one or more devices external to storage container 1010, such as UAV 102, server 110, mobile device 140, etc. The wireless communication device is configured to exchange data stored in storage medium 1050 of storage container 1010 with the devices external to the storage container. The wireless communication device may support any suitable wireless communication technology, such as Radio-frequency identification (RFID), Bluetooth communication, Wi-Fi, radio communication, cellular communication, ZigBee, infrared (IR) wireless, microwave communication, etc.

Furthermore, storage container 1010 may include a WiFi system-on-chip (SoC) that enables storage container 1010 to provide a wireless link(s) as a hotspot. Storage container 1010 may exchange data stored in memory storage medium 1050 with other devices via wireless link(s) and/or physical interface. For example, storage container 1010 may exchange range data from UAV 102 with mobile device 140. In some exemplary embodiments, storage container 1010 may exchange data from UAV 102 with other users.

It is to be understood that the disclosed exemplary embodiments are not necessarily limited in their application to the details of structures and the arrangement of the components set forth in the following description and/or illustrated in the drawings and/or the examples. The disclosed exemplary embodiments may have variations, or may be practiced or carried out in various ways.

It will be apparent to those skilled in the art that modifications and variations can be made to the disclosed devices and systems. Other embodiments will be apparent to those skilled in the art from consideration of the specification and practice of the disclosed devices and systems. It is intended that the specification and examples be considered as exemplary only, with a true scope being indicated by the following claims and their equivalents.

What is claimed is:

1. A system of an unmanned aerial vehicle (UAV), comprising:
a first body configured to fly;
a second body detachably attached to the first body and configured as a handheld stabilizer;
a power supply system configured to power the first body and the second body;
one or more sensors;
at least one processor; and
at least one storage medium storing instructions that, when executed, instruct the at least one processor to receive sensor data from the one or more sensors.

2. The system of claim 1, wherein the second body includes a carrier configured to adjust a load detachably connected to the carrier.

3. The system of claim 2, wherein the carrier is a gimbal.

4. The system of claim 1, wherein
the second body includes a user interface; and
the user interface includes a display screen configured to display information of the system.

5. The system of claim 4, wherein the display screen is a touchscreen configured to receive a user command.

6. The system of claim 5, wherein the second body includes a remote control configured to control the first body when the second body is detached from the first body.

7. The system of claim 5, wherein the first body is a sub-UAV when the second body is detached from the first body.

8. The system of claim 5, wherein the at least one processor is further configured to:
receive the user command; and
control the UAV to fly according to the user command.

9. The system of claim 8, wherein
the user command incudes one or more parameters; and
the one or more parameters include at least one of:
a flight mode, or
one or more predetermined flight trajectories.

10. The system of claim 9, wherein the processor is further configured to:
conduct a self-inspection and an environmental inspection upon receiving the user command; and
determine whether a taking off condition is met based on the flight mode, the self-inspection and the environmental inspection.

11. The system of claim 1, wherein the one or more sensors include:
one or more first range sensors on a front side of the first body;
one or more second range sensors on a rear side of the first body;
one or more third range sensors on a left side of the first body; and
one or more fourth range sensors on a right side of the first body.

12. The system of claim 11, wherein a combination of the one or more first range sensors, the one or more second range sensors, the one or more third range sensors and the one or more fourth range sensors covers a horizontal angle of view of at least 360°.

13. The system of claim 2, wherein
the load includes an imaging sensor;
the one or more sensors include:
one or more first range sensors on a front side of the first body, and
one or more second range sensors on a rear side of the first body; and
when the UAV is configured to operate in an obstacle avoidance flight mode:
the carrier adjusts the load to rotate so as to keep the imaging sensor facing towards a target, and
the obstacle avoidance flight mode is achieved by the imaging sensor, the one or more first range sensors and the one or more second range sensors.

14. The system of claim 1, wherein
the first body includes a first layer and a second layer connected with the first layer via a steering mechanism;
the one or more sensors includes:
one or more first range sensors on a front side of the first layer, and
one or more second range sensors on a rear side of the first layer; and
when the UAV is configured to operate in an obstacle avoidance flight mode:
the steering mechanism steers the first layer to rotate with respect to the second layer, and
the obstacle avoidance flight mode is achieved by operating the one or more first range sensors and the one or more second range sensors based on the first layer rotating with respect to the second layer.

15. The system of claim 1, wherein the power supply system includes:
a first battery assembly associated with the first body; and
a second battery assembly associated with the second body.

16. The system of claim 1, wherein the at least one processor includes:
a tier-two processor associated with the first body; and
a tier-one processor associated with the second body, wherein
the tier-one processor has a stronger data processing capability than the tier-two processor.

17. The system of claim 1, wherein
the first body includes:
one or more arms, wherein each arm is pivotally coupled to the first body, and
one or more propulsion devices mounted on the one or more arms; and
the one or more arms are configured to switch between a flight configuration and a compact configuration, wherein
the one or more arms extend away from the first body in the flight configuration, and
the one or more arms are folded and closely placed relative to the first body in the compact configuration.

18. The system of claim 17, wherein
the first body is capable of flying when the first body is detached from the second body; and
the first body further includes:
a controller configured to control the one or more propulsion devices, and
a battery configured to provide power to the controller and the one or more propulsion devices.

19. The system of claim 1, further comprising a storage container configured to store the first body and the second body.

20. The system of claim 19, wherein
the storage container includes a power source and a receiving portion configured to store the power supply system; and
the receiving portion includes a power connector configured to connect the power supply system with the power source when the power supply system is stored in the receiving portion.
